(19) United States
(12) Patent Application Publication
(10) Pub. No.: US 2023/0097082 A1
(43) Pub. Date: Mar. 30, 2023

(54) Filter vessel, apparatus and method for preparing a filtrate

(71) Applicant: Wolfgang MUCKENHUBER, Schwaig (DE)

(72) Inventor: Wolfgang MUCKENHUBER, Schwaig (DE)

(21) Appl. No.: 17/800,070

(22) PCT Filed: Feb. 17, 2021
(86) PCT No.: PCT/EP2021/053824

§ 371 Date: Aug. 16, 2022

(30) Foreign Application Priority Data
Feb. 17, 2020 (DE) 10 2020 104 079.2

(51) Int. Cl. A47J 31/02; A47J 31/06

(52) U.S. Cl. CPC A47J 31/02; A47J 31/0626; A47J 31/0684

(57) ABSTRACT

A filter vessel for preparing a filtrate, in particular of coffee or tea, comprises a cylindrical chamber with a filling opening at the upper end and a base having a filter region at the lower end. During a filtration process, the filter vessel can be placed onto a receiving container. The contact region between the filter vessel and the receiving container is hermetically sealed in an air-tight manner. A negative pressure can be generated in the receiving container by an evacuation device. The filter vessel comprises, on its underside, a recess surrounding the filter region. The recess receives the rim of an opening of the receiving container. A seal is situated in the recess. An air duct has a first duct opening located on the underside of the filter vessel inside the seal, and a second duct opening, which is suitable for connection to the evacuation device.

### TECHNICAL FIELD

The present disclosure relates to a filter vessel for preparing a filtrate, in particular of coffee or tea. In addition, the present disclosure relates to an apparatus comprising the filter vessel and to a method for preparing a filtrate.

### BACKGROUND

Filtration is a process for separating substances, for example a suspension. Filtration is a mechanical separation process that is based exclusively on physical principles. The filtered liquid is called the filtrate. A filter medium is used for filtration, wherein, in the case of surface filtration, the filtered-off solids form a residue layer on the filter medium, the so-called “filter cake.”

Coffee preparation by means of vacuum or negative pressure method is known. For this purpose, two glass spheres are connected to each other by means of a rubber sleeve via a riser tube. This is equipped with a valve that opens when a certain negative pressure is reached. Water is filled in the lower glass sphere and coffee powder is filled in the upper one. The water is heated and rises into the upper flask, where mixing with the coffee powder occurs. The cooling of the lower flask creates a negative pressure, which sucks the coffee brewed in the upper flask back into the lower glass flask. The coffee grounds remain in the upper flask.

A Nutsche filter or a Buchner funnel is known from the chemical laboratory. This is a filter for the mechanical separation of a suspension. The Nutsche filter has a cylindrical shape and a flat base with small openings. For filtration, these are covered with a filter paper, which can be removed with the solids after filtration. At the lower end, the Nutsche filter has a funnel. For the suction or vacuum filtration of solids, a Nutsche filter is used together with a suction flask. For this purpose, the funnel of the Nutsche filter is inserted into the suction flask and is connected in an air-tight manner with a rubber sleeve. The suction flask is connected to a pump to generate the negative pressure.

EP 0 900 541 A1 discloses an apparatus for the production of aroma extracts, in particular of coffee or tea. Such apparatus comprises a receiving container and a filter which is seated on the receiving container. The contact region between the filter vessel and the receiving container is hermetically sealed in an air-tight manner, and an air extraction duct of an evacuation device opens into the receiving container in the upper rim region of the receiving container. A negative pressure is generated in the receiving container, which sucks an extraction liquid in the filter vessel into the receiving container.

WO 2019/150163 A1 describes a portable coffee maker apparatus with negative pressure extraction. The apparatus comprises two chambers, one open and one closed, connected by one or more flow openings separated by a filter, wherein a suction air pump exerts a negative pressure on the closed chamber via a suction opening and the liquid in the open chamber is sucked in by the negative pressure through the flow openings into the closed chamber, wherein the filter ensures that filtration residues remain in the open chamber. This machine can be used to prepare coffee and tea and generally beverages prepared by filter extraction. Thereby, the pump is located in the open chamber and is battery operated.

FR 83 175 discloses a filter that can be inserted into a pot, thus dividing it into two halves, wherein coffee and water are poured into the upper half and a negative pressure is generated in the lower half of the pot through an air duct in the filter by means of an external pump, such that a filtrate is extracted.

US 2006/0260471 A1 describes a coffee or tea filter press comprising a hollow cylinder having upper and lower openings, a perforated removable cap enclosing the lower opening, a removable plunger inserted into the upper opening and pushed downward to force liquid in the cylinder through the perforated cap, and a holder for holding the press over the opening of an open vessel.

### SUMMARY

An object of the present disclosure is to provide a novel filter vessel along with a method with which, with an advantageous filtration efficiency, increased flexibility in use is simultaneously made possible with simplified handling.

The preceding object is achieved by the subject matter as claimed, by an apparatus as described and claimed, and by a method as described and claimed.

A filter vessel for preparing a filtrate, in particular of coffee or tea, comprises a cylindrical chamber, which comprises a filling opening at the upper end and a base having a filter region at the lower end. During a filtration process, the filter vessel can be placed onto an, in particular variable, receiving container. The contact region between the filter vessel and the receiving container is hermetically sealed in an air-tight manner. A negative pressure can be generated in the receiving container by an evacuation device. The filter vessel comprises, on its underside, a recess surrounding the filter region. The recess is designed to receive the rim of an opening of the, in particular variable, receiving container. A seal is arranged in the recess. An air duct is arranged in the filter vessel and has a first duct opening, which is located on the underside of the filter vessel inside the seal, and a second duct opening, which is suitable for connection to the evacuation device.

The filter vessel has a filling opening at the upper end for the entry of filters and/or substances or flavors, such as coffee powder or tea. Water or a different suspension can also be filled in here. The chamber of the filter vessel is preferably an open cylindrical chamber. Advantageously, the chamber does not have a lid. The chamber can also remain open at the top during an extraction process. In an alternative embodiment, the chamber can have a conical shape, particularly the shape of a truncated cone. The top surface of this truncated cone can preferably form the base, in particular a flat base, of the chamber.

In a particularly preferred embodiment, the filter vessel can be made of plastic. Advantageously, the filter vessel can be manufactured in one piece, such that the filter vessel can substantially consist of only one part. The seal along with a filter, which can be inserted into the filter region, may be excluded from the one-piece design, as can a receiving container or an evacuation device. The filter vessel can thus advantageously be formed from one piece of the same material.

The filter vessel can advantageously be manufactured from a plastic by injection molding. Possible plastics may include, for example, polyethylene (PE), polypropylene (PP), and polyethylene terephthalate (PET). Further, it is possible that at least a part of the filter vessel is made of polymethyl methacrylate (PMMA). In an alternative embodiment, the filter vessel can be made entirely or partially of glass and/or ceramic.

In a preferred embodiment, the height of the seal arranged in the recess can be less than the height of the recess. In an alternative embodiment, the height of the seal can correspond to the height of the recess. Preferably, the seal can be a flat seal. This can further simplify placement on the upper rim of a, in particular variable, receiving container. The flat seal can preferably have a greater radial extent, that is, width, than the width of the rim of the receiving container, that is, the wall thickness of the receiving container. In this way, it is advantageous to ensure complete airtight coverage of the rim even for receiving container openings of different sizes. Preferably, the filter vessel can consist of a part with an integrated flat seal. The seal is expediently a universal fit for a receiving container. The receiving container can advantageously be dimensioned such that a portion of the filtrate, in particular a drinking portion of coffee or a drinking portion of tea, can be received therein. This has the advantage that a drinking portion can be dispensed directly into a drinking vessel provided for this purpose with the filter vessel. The filtrate, for example a portion of coffee or tea, can then advantageously be consumed directly from the drinking vessel without the need to pour the filtrate to another container. Thus, it is not necessary to use a pot or similar container designed for more than one portion of the filtrate for the extraction process. This has the advantage that it is not necessary to pour the filtrate from the receiving container to another drinking vessel.

The recess may have a base and two side walls. The seal is preferably positioned at the base of the recess such that, when in place, a sealing is formed from the top to the rim of the receiving container. A sealing from above can mean that the plane of the seal is at or above the plane of the rim of the opening of the receiving container. Thereby, the plane of the seal is expediently not below the plane of the rim of the opening of the receiving container, such that the sealing does not take place on the inner wall and/or the outer wall of the receiving container. In an alternative embodiment, a part of the seal can also be located on the walls of the recess, such that there is a frustoconical seal that engages the rim of the receiving container from the inside and/or from the outside. When in place, the filter vessel is advantageously held in the desired position by the receiving container or a drinking vessel, as the case may be. Thereby, the sealing can be achieved by the filter vessel's own weight. Advantageously, no additional adapter is required for placing the filter vessel on the receiving container.

Due to the fact that the filter vessel sits on the rim of the receiving container, no penetration of the filter vessel or the seal into the receiving container, as the case may be, is necessary for the sealing. Thus, it is expedient that it is a placed-on device and not an insert, such that, advantageously, no space is taken up within the receiving container for the sealing. Thus, the full radius or the entire surface, as the case may be, of the filter region is available for an extraction process. This can have a positive effect on suction capacity, such that the filtrate can be obtained in a shorter period of time.

Advantageously, the seal can be placed on different drinking vessels, such as cups, glasses or tumblers of different sizes. Thereby, the radial extent of the seal or recess, as the case may be, can be expediently adapted to the size of the opening of relevant drinking vessels. There is a possibility that the seal or drinking vessel is adapted to certain classes of cups. A division is usually made into:
“Mug” (with a height-to-width ratio of approximately 3:1 and a capacity of 0.33-0.4 l),
“Tumbler” (with a height-to-width ratio of approximately 2:1 and a capacity of 0.3-0.4 l),
“Cup” (tumbler with handle, with a height-to-width ratio of approximately 2:1 and a capacity of 0.3-0.4 l),
“Coffee cup” (with a height-to-width ratio of approximately 1:1 and a capacity of 0.2-0.25 l),
“Teacup” (with a height-to-width ratio of approximately 1:2 and a capacity of 0.2-0.25 l),
“Bowl (with a height-to-width ratio of approximately 1:2 and a capacity of 0.35-0.5 l) and
“Soup cup” (with a height-to-width ratio of approximately 1:3 and a capacity of 0.35-0.5 l).

A prerequisite for a suitable receiving container that can be used with the filter vessel is that it can be vacuumed. For this purpose, the receiving container can preferably have only one opening, which can be closed airtight by the seal of the filter vessel. Furthermore, it must be ensured that the size or dimensioning of the receiving container is adapted to the filter vessel and, conversely, that the size or dimensioning of the filter vessel is adapted to the receiving container.

The filter vessel or the method are advantageously independent of the receiving container. Thus, for example, there is no need for an air connection or a vacuum connection, as the case may be, on the receiving container or any other special design. The filter vessel can thus be used for various receiving containers or drinking vessels, as the case may be, independently of the receiving container specifically used. Thus, it is compatible with conventional receiving containers or drinking vessels, as the case may be.

The filter region can expediently extend over 30%, in particular over 50%, in particular over 75%, in particular over 90% of the base surface or the base, as the case may be, of the filter vessel. For this purpose, the filter region can be designed as a perforated surface, which is suitable for inserting a filter, for example. The filter can expediently be a horizontal and/or disk-shaped filter. The filter can be made of paper, textile fabric, plastic or metal, for example. In an alternative embodiment, the filter can be permanently integrated into the filter region and made of plastic or metal. Alternatively, there is the possibility of an integrated filter plate or sieve plate, as the case may be.

The sizes and proportions along with the material of the filter vessel are advantageously designed for easy and thorough cleaning. For example, the filter vessel can preferably be dishwasher-safe and have no tapered and/or difficult-to-clean areas. It is particularly advantageous for this purpose that the filtrate, after leaving the filter region, is not passed through a tapering point for collection, in particular not through a funnel, a duct or an adapter. The filtrate can advantageously be discharged directly, that is, without collection, into the receiving container after passing through the filter or filter region, as the case may be. Preferably, the discharge can take place over the entire surface of the filter region or the opening, as the case may be, of the receiving container. The plane of the filter region can project into the receiving container for this purpose. The filter region can preferably simultaneously form the outlet opening of the filter vessel for the filtrate.

Preferably, a planar filter region can be provided, which is located in a plane parallel to the base of the filter vessel. The seal can further be arranged in a plane parallel to the base of the filter vessel. The filter region can preferably be designed as a depression in the base of the filter vessel. Around the filter region, the base can form a rim that can, for example, facilitate filter replacement. In addition, this can facilitate the removal of the retentate or pulp or filter cake, as the case may be, after the filtration process.

An air duct is arranged in the filter vessel. Preferably, the air duct can be integrated into the filter vessel such that the air duct runs in the material of the filter vessel body. In a preferred embodiment, the air duct runs in the base or in the plane of the base, as the case may be, of the filter vessel. The air duct also has two duct openings, wherein the first duct opening is located on the underside of the filter vessel inside the seal. When the filter vessel is placed on a receiving container, the first duct opening thus points into the receiving container and lies within the rim of the opening of the receiving container. Thus, the first duct opening opens into the receiving container. The first duct opening can preferably be located in the recess, within the circumferential seal. In an alternative embodiment, the first duct opening can be located at the filter plane.

The second duct opening can expediently be arranged on the outer side or on the outer wall, as the case may be, of the filter vessel. This can ensure the connection of an evacuation device. Advantageously, an outlet nozzle can be arranged at the second duct opening, which is particularly suitable for connecting an air hose or a vacuum hose, as the case may be. Provided that the air duct runs within the base of the filter vessel, the second duct opening can be located in the plane of the base. In a preferred embodiment, the second duct opening can be located above the plane of the filter region and/or above the plane of the seal.

Advantageously, the filter vessel can have a stand on the underside that surrounds the filter region and has at least one stand surface. The stand surface can be located in a plane parallel to the plane of the base of the filter vessel. Preferably, the plane of the filter region is higher than the plane of the stand, that is, between the plane of the stand surface and the plane of the filling opening, such that the filter vessel can be set down next to the receiving container after use, that is, after a filtration process, without the filter region resting on or touching, as the case may be, the set-down surface. This has the advantage that there is no soiling of the set down surface by filtration residues in the filter region or on the underside of the filter vessel. It is also possible that the plane of the filter region is located between the plane of the stand surface and the plane of the seal. The stand can be arranged radially between the filter region and the recess and/or arranged circumferentially around the recess. The stand surrounding the recess can advantageously provide stability and thus reduce the risk of the filter vessel falling over. In an alternative embodiment, the stand can form at least one wall of the recess, wherein it can be the inner wall and/or the outer wall of the recess. Expediently, the base can be designed to be continuous, that is, without interruptions. In an alternative embodiment, the stand can be designed with interruptions or segmented, as the case may be. The interruptions and/or the segmentation have the advantage that, after use of the filter vessel, when it is placed on a flat surface, air circulation to the filter region can take place from below such that, for example, waterlogging can be avoided or drying can be ensured, as the case may be.

In a further aspect, an apparatus for preparing aroma extracts, in particular of coffee or tea, comprises a receiving container, in particular one that is variable in size, for the finished filtrate and a filter vessel with an open cylindrical chamber having a filling opening at the upper end and a base with a filter region at the lower end. The filter vessel is seated on the receiving container during a filtration process. The contact region between the filter vessel and the receiving container is hermetically sealed in an air-tight manner. A negative pressure can be generated in the receiving container by an evacuation device. The filter vessel comprises, on its underside, a recess surrounding the filter region. The recess is designed to receive the rim of an opening of the, in particular variable, receiving container. A seal is arranged in the recess. An air duct is arranged in the filter vessel and has a first duct opening, which opens into the receiving container and is located on the underside of the filter vessel inside the seal, and a second duct opening, which is suitable for connection to the evacuation device.

The evacuation device can preferably be a manually operated pump, a diaphragm pump or a water jet pump. Thus, the negative pressure is generated externally and not via a device integrated into the filter vessel. In one embodiment, the generation of the negative pressure or of the vacuum, as the case may be, takes place by means of manually operated pumps and/or bellows. Such embodiment is particularly suitable for end users. In an alternative embodiment, the generation of the negative pressure or the vacuum, as the case may be, takes place by means of an external suction apparatus supplied with mains voltage. Such automated design is particularly suitable for commercial applications. In addition, special pumps may also be intended for use with the described filter vessel or method, as the case may be.

In a further aspect, a method for preparing a filtrate, in particular of coffee or tea, includes introducing a mixture to be separated, in particular a suspension, into a filter vessel. The filter vessel, with an open cylindrical chamber having a filling opening at the upper end and a flat base with a flat filter region at the lower end, is seated on a, in particular variable, receiving container. The contact region between the filter vessel and the receiving container is hermetically sealed in an air-tight manner. A negative pressure is generated in the receiving container by an evacuation device. An apparatus in accordance with one of the above embodiments is used. The evacuation device is connected to the filter vessel, such that a suction effect is created in the direction of the filter vessel to generate the negative pressure in the receiving container. The filtrate is discharged from the filter region directly, in particular over its entire planar extent, into the receiving container.

In order to obtain a static negative pressure in the receiving container, a dynamic suction is generated in the direction of the first duct opening and thus in the direction of the filter vessel. Furthermore, the filtrate is discharged from the filter region directly into the receiving container. Advantageously, this can be done over the entire surface of the filter region. This has the advantage that the suction effect is optimized and can be applied independently of the receiving container.

The method offers the further advantage that the complete separation of the liquid from the suspension or pulp, as the case may be, can be achieved within a short period of time. This does not require the application of a high degree of mechanical force. There is also no need for the application of manual pressure. This makes this method highly user-friendly and easy to implement for an end user. In addition, the structure of filter vessel and the receiving container is highly stable, since the filter vessel sits on the rim of the receiving container and is held in the correct position by its own weight. In addition to manual operation, for example with a hand pump, partial or full automation is also possible, for example with a mains-operated pumping unit. Partial or full automation is particularly suitable for use in the restaurant industry, such that multiple filtrations can be carried out within a short period of time. The ease with which the filter vessel can be cleaned is an advantage, such that hygiene standards in particular can be maintained in a simple manner.

Another advantage is the direct extraction of the filtrate into the receiving container. Thus, the rapid and direct preparation of a coffee extract in the drinking vessel is possible, while the drinking vessel is interchangeable. The applied negative pressure allows the brewing water to be separated from the coffee grounds or tea at an accelerated rate.

Furthermore, this results in the possibility of easy portioning, since a portion of an aroma extract can be produced as required.

### BRIEF DESCRIPTION OF THE DRAWINGS

Expedient embodiments of the present invention are explained in more detail below with reference to figures of drawings:

FIG. 1 is a highly simplified sectional view of a filter vessel;

FIG. 2a, FIG. 2b, FIG. 2c, and FIG. 2d are partial illustrations of different designs of the filter vessel;

FIG. 3a and FIG. 3 b are highly simplified illustrations of the filter vessel in a top view and a bottom view;

FIG. 4 is a highly simplified schematic illustration of an apparatus consisting of a filter vessel and a receiving container; and

FIG. 5a and FIG. 5b are highly simplified schematic illustrations of a filtration process by means of the apparatus.

### DETAILED DESCRIPTION

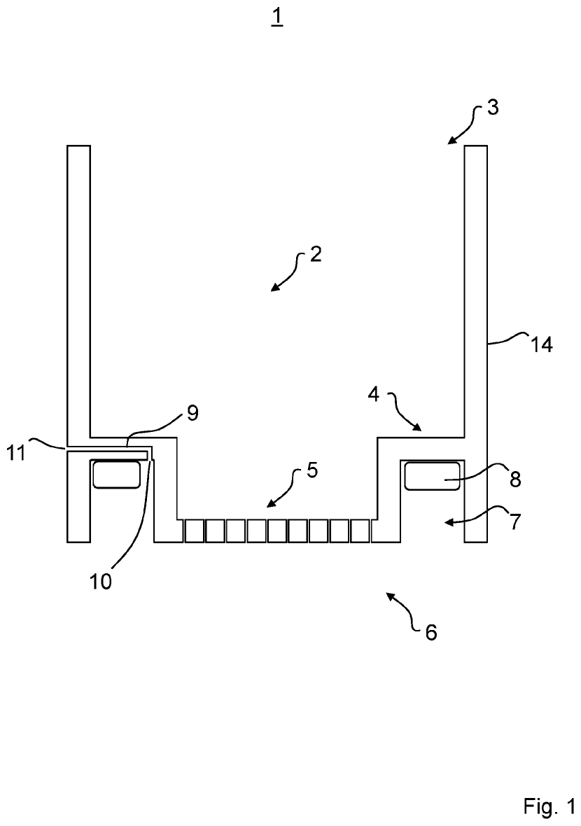

In FIG. 1, a filter vessel 1 is shown in a sectional view. The filter vessel 1 consists of a cylindrical chamber 2, which comprises a filling opening 3 at the upper end and a base 4 at the lower end. A filter region 5 is arranged in the base 4. On the underside 6 of the filter vessel 1, there is a recess 7 surrounding the filter region 5. A seal 8 is arranged in the recess 7, which seal surrounds the filter region 5, in order to ensure an airtight seal when placed on a receiving container 20. Here, the section of the illustration runs parallel with the air duct 9, which has a first duct opening 10 and a second duct opening 11. The first duct opening 10 is located on the underside 6 inside the seal 8 and the second duct opening 11 is located on the outer side or on the outer wall 14, as the case may be, of the filter vessel 1.

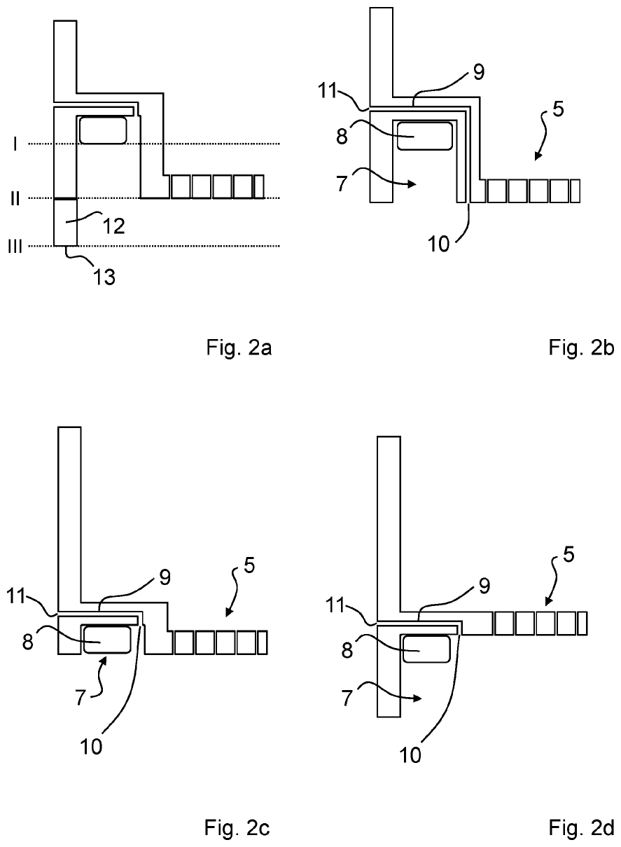

FIG. 2a to FIG. 2d show partial illustrations of different embodiments of the filter vessel 1. FIG. 2a shows an embodiment of a filter vessel 1 with a stand 12. The stand 12 comprises a stand surface 13 on which the filter vessel 1 can be placed. Furthermore, three planes Ito III are shown in FIG. 2a. Plane I shows the plane of the seal 8, wherein plane II shows the plane of the filter region 5. Plane III runs through the stand surface 13 of the stand 12. The embodiment shown in FIG. 2b has a first duct opening 10 of the air duct 9, which is located at the filter plane 5. The recess 7 in FIG. 2c has a depth of the same order of magnitude as the height of the seal 8. Thereby, the seal 8 and the filter region 5 are on the same plane. FIG. 2d shows a recess 7, which has only one side wall. Thereby, such side wall of the recess 7 can simultaneously form a stand 12.

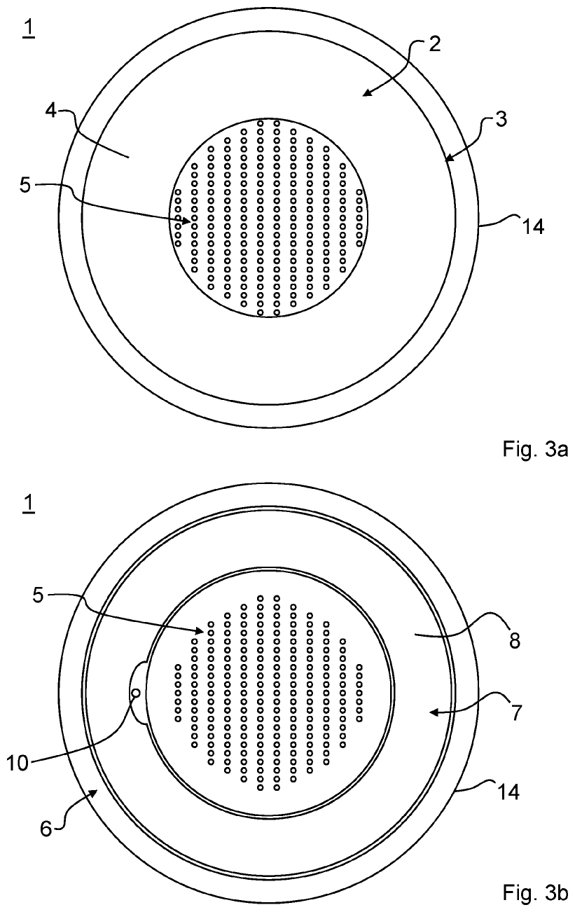

FIG. 3a and FIG. 3b show illustrations of a filter vessel 1 in a top view and in a bottom view from below. The top view in FIG. 3a shows the filter vessel 1, which has a cylindrical chamber 2 with a filling opening 3. The base 4 includes a filter region 5 in a central arrangement. The bottom view in FIG. 3b shows the underside 6 of the filter vessel 1. The filter region 5 is arranged in a central position with a circumferential recess 7. The seal 8 is located in the recess 7. The first duct opening 10 of the air duct 9 is located in the recess 7 inside the seal 8. The seal 8 has a small recess for the first duct opening 10.

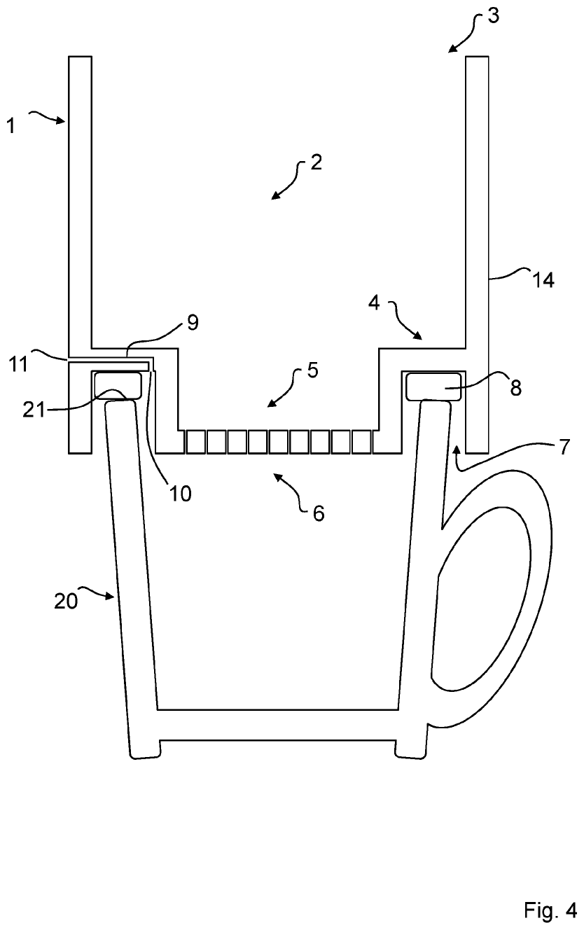

FIG. 4 shows a schematic illustration of an apparatus consisting of a filter vessel 1 and a receiving container 20. The filter vessel 1 is located on the rim 21 of the receiving container 20 when in place. The upper rim 21 of the receiving container 20 is thereby received by the recess 7. The contact region between the filter vessel 1 and the receiving container 20 is hermetically sealed in an air-tight manner by the seal 8. The underside 6 of the filter region 5 projects into the opening of the receiving container 20.

The first duct opening 10 of the air duct 9 is connected to the interior of the receiving container 20.

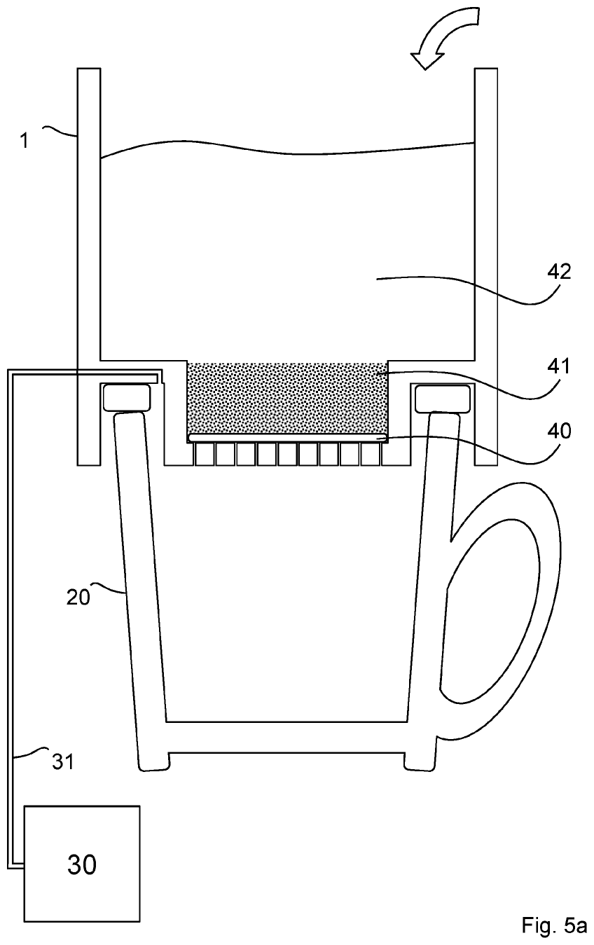

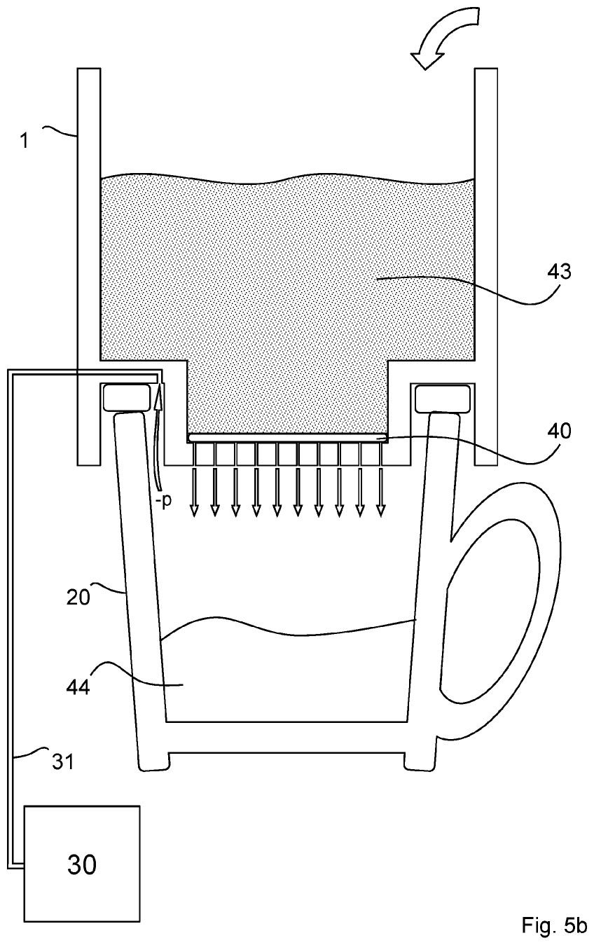

FIG. 5a to FIG. 5b show a filtration process by means of the apparatus. In FIG. 5a, a filter 40 is inserted into the filter region 5 of the filter vessel 1. The filter 40 is expediently designed as a horizontal and/or disk-shaped filter. Coffee powder 41 is placed onto the filter 40. Water 42 has been added from above to the coffee powder 41 in the filter vessel 1. In addition, a vacuum hose 31 is connected to the second duct opening 11, which connects the air duct 9 to an evacuation device 30. In FIG. 5b, a negative pressure −p is generated in the receiving container 20 by means of the evacuation device 30. This results in a suction effect on the suspension 43 in the filter vessel 1. The suspension 43 is thereby sucked through the filter 40 into the receiving container 20. The filtrate 44 is collected in the receiving container 20.

The content of the disclosure also expressly covers individual combinations of features (sub-combinations) along with possible combinations of individual features of different design forms not shown in the drawing figures.

### LIST OF REFERENCE SIGNS

1 Filter vessel
2 Chamber
3 Filling opening
4 Base
5 Filter region
6 Underside
7 Recess
8 Seal
9 Air duct
10 First air duct opening
11 Second air duct opening
12 Stand
13 Stand surface
14 Outer wall
20 Receiving opening
21 Rim of the receiving container opening
30 Evacuation device
31 Vacuum hose
40 Filter
41 Coffee powder
42 Water
43 Suspension
44 Filtrate

1.-10. (canceled)

11. A filter vessel (1) for preparing a filtrate (44), in particular of coffee or tea, the filter vessel comprising:
a chamber (2), which comprises
a filling opening (3) at an upper end and
a base (4) with a filter region (5) at a lower end;
a seal (8) surrounding the filter region (5), the seal having a flat lower surface; and
an air duct (9) arranged in the filter vessel (1), the air duct (9) having
a first duct opening (10), which is located on the underside (6) of the filter vessel (1) inside the seal (8), and
a second duct opening (11), which is suitable for connection to an evacuation device (30),
wherein, during a filtration process, the filter vessel (1) can be placed onto a receiving container (20),
wherein a contact region between the filter vessel (1) and the receiving container (20) is hermetically sealed in an airtight manner, and
wherein a negative pressure can be generated in the receiving container (20) by the evacuation device (30), and
wherein the flat lower surface of the seal (8) is designed to be placed onto a rim (21) of an opening of the receiving container (20).

12. The filter vessel (1) according to claim 11,
wherein the filter vessel (1) has, on the underside (6), a stand (12) that surrounds the filter region (5) and has at least one stand surface (13).

13. The filter vessel (1) according to claim 12,
wherein the stand (12) extends downwardly below the filter region (5).

14. The filter vessel (1) according to claim 11,
wherein the filter vessel (1) is made of plastic.

15. The filter vessel (1) according to claim 11,
wherein the seal (8) is supported within a recess (7) of the chamber (2).

16. The filter vessel (1) according to claim 11,
wherein the second duct opening (11) is arranged on an outer wall (14) of the filter vessel (1).

17. The filter vessel (1) according to claim 11,
wherein the filter region (5) extends over 30% of the base (4) of the filter vessel (1).

18. The filter vessel (1) according to claim 11,
wherein the filter vessel (1) is a single piece made of a single material.

19. The filter vessel (1) according to claim 11,
wherein the filter vessel (1) is configured to accommodate receiving containers having different sizes.

20. The filter vessel (1) according to claim 11,
wherein the chamber (2) is cylindrical or cone-shaped.

21. An apparatus for preparing aroma extracts, in particular of coffee or tea, comprising:
a filter vessel (1), comprising
a cylindrical or cone-shaped chamber (2), which comprises
a filling opening (3) at an upper end and
a base (4) with a filter region (5) at a lower end,
a recess (7) surrounding the filter region (5) arranged at an underside (6) of the filter vessel (1);
a seal (8) surrounding the filter region (5); and
an air duct (9) arranged in the filter vessel (1), the air duct (9) having
a first duct opening (10), which is located on the underside (6) of the filter vessel (1) inside the seal (8), and
a second duct opening (11), which is suitable for connection to an evacuation device (30); and
a receiving container (20) for a finished filtrate (44),
wherein the filter vessel (1) is seated on a rim of the receiving container (20) during a filtration process,
wherein a contact region between the filter vessel (1) and the receiving container (20) is hermetically sealed in an airtight manner, and
wherein a negative pressure can be generated in the receiving container (20) by the evacuation device (30)

22. The apparatus according to claim 21,
wherein the filter vessel (1) is configured to accommodate receiving containers having different sizes.

23. A method for preparing a filtrate (44), in particular of coffee or tea, comprising:
introducing a mixture to be separated into a filter vessel (1) according to claim 11;
seating the filter vessel (1) on a receiving container (20);
connecting an evacuation device (30) to the filter vessel (1);
generating a negative pressure in the receiving container (20) by the evacuation device (30); and
discharging the filtrate (44) from the filter region (5) directly into the receiving container (20).
